(19) United States
(12) Patent Application Publication
(10) Pub. No.: US 2023/0143471 A1
(43) Pub. Date: May 11, 2023

(54) SLUG WELD WITH INCREASED SURFACE CONTACT AREA

(71) Applicant: Dana Heavy Vehicle Systems Group, LLC, Maumee, OH (US)

(72) Inventors: Steve BYRNE, Holland, OH (US); Dakota DAWSON, Maumee, OH (US)

(21) Appl. No.: 17/454,014

(22) Filed: Nov. 8, 2021

(51) Int. Cl. B60B 35/16; B23K 11/02; B23K 11/00

(52) U.S. Cl. CPC B60B 35/16; B23K 11/02; B23K 11/002; B23K 2101/006

(57) ABSTRACT

A method for joining first and second axle components is provided. In one example, the method includes forming an aperture in a first axle component that is mounted to a second axle component, where the aperture has a chamfer at one end thereof, inserting an object into the aperture, and resistance welding the aperture while applying pressure to the object so that the object fills the chamfer.

### TECHNICAL FIELD

The present invention relates generally to forge welding and, more particularly, to an apparatus and method of forge welding components together.

### BACKGROUND AND SUMMARY

During the production of axle assemblies for vehicles, various techniques, such as welding, have been used to join an axle tube to an axle housing or to a differential carrier. For instance, resistance welding with a cylindrical plug is one process conventionally used in the production of axle assemblies. In this process, a housing having a neck that forms an opening for receiving the tube is provided. A cylindrical aperture is formed on the neck of the housing to receive the plug. The tube is press-fit into the opening and the plug is inserted into the aperture. Electrodes then apply pressure to force the plug against the tube while electrical current passes through the interface between the plug and the tube. Heat generated by the current deforms the plug as the interface reaches a plastic state. The plug cools to become welded to the tube after the current is shut off. The welded plug acts like a fastener to secure the tube to the housing.

The inventors have recognized several drawbacks with these welding techniques. For instance, in the cylindrical plug welding described above, the contact area of the weld (e.g., between the plug and the axle tube) is determined by the size of the aperture. While a larger contact area is desired for increasing the torsional strength and resistance of the weld, increasing the size of the aperture may compromise the strength of the housing at the neck where the aperture is located. Since defective axle assemblies are expensive to replace once incorporated into a larger system, ensuring that the tube is properly joined to the housing is imperative to, for instance, avoid premature degradation of the axle components, expensive warranty repairs, and/or product recall. Therefore, the inventors have recognized an unmet need for a technique for joining an axle tube to a housing with a welded connection having a larger contact area, without increasing the size of the aperture.

To resolve at least a portion of the aforementioned issues, the inventors have developed a method for joining first and second workpieces, particularly first and second axle components. In one example, the method includes forming an aperture in a first axle component that is mounted to a second axle component, where the aperture includes a chamfer at one end thereof. The method further includes inserting an object, which is sized to fit into the aperture, into the aperture. The method further includes resistance welding at the aperture while applying a variable pressure to press on the object, where the pressure is adjusted to a first, higher level during a first portion of the welding and subsequently adjusted to a lower level during a second, later portion of the welding as the object fills the chamfer. In this way, by filling the chamfer with the object during welding, the welded connection formed by the object between the first and second axle components has a contact surface area larger than the area of the aperture, thereby providing increased torsional strength and resistance at the connection. Further, by forming the aperture in the first axle component with a chamfer in this manner, this welded connection having increased contact area can be realized without increasing the size of the aperture, so that the strength of the first axle component is not compromised.

In another example, the method may include adjusting the pressure based on an angle of the chamfer. In such an example, a higher chamfer angle corresponds to a higher first pressure level. In this way, the variable pressure can be adjusted to effectively force the object to substantially fill the chamfer during the first portion of the welding to provide a secure welded connection, as described above, for apertures having various chamfer angles in different applications.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a perspective view of an axle assembly having an axle tube joined to an axle housing.

FIG. 2 shows a detailed cross-sectional view of a portion of the axle assembly depicted in FIG. 1, particularly illustrating a welded joint between the axle tube and the axle housing.

FIG. 3 is a schematic block diagram illustrating a welding apparatus for creating the welded joint shown in FIG. 2.

FIG. 4 shows a deformable rivet positioned for joining the axle tube to the axle housing, according to one example.

FIG. 5 is a graph illustrating the position of the hot forging electrode as a function of rivet deformation, the rivet temperature, and the pressure on the deformable rivet during the deformation sequence.

FIG. 6 is a graph illustrating pressure applied to the rivet during a portion of welding as a function of a chamfer angle, according to two examples.

FIG. 7 is a flow chart illustrating a method for forming a welded joint according to one example.

FIGS. 8A-8B show different views of another axle assembly having an axle tube joined to a differential carrier.

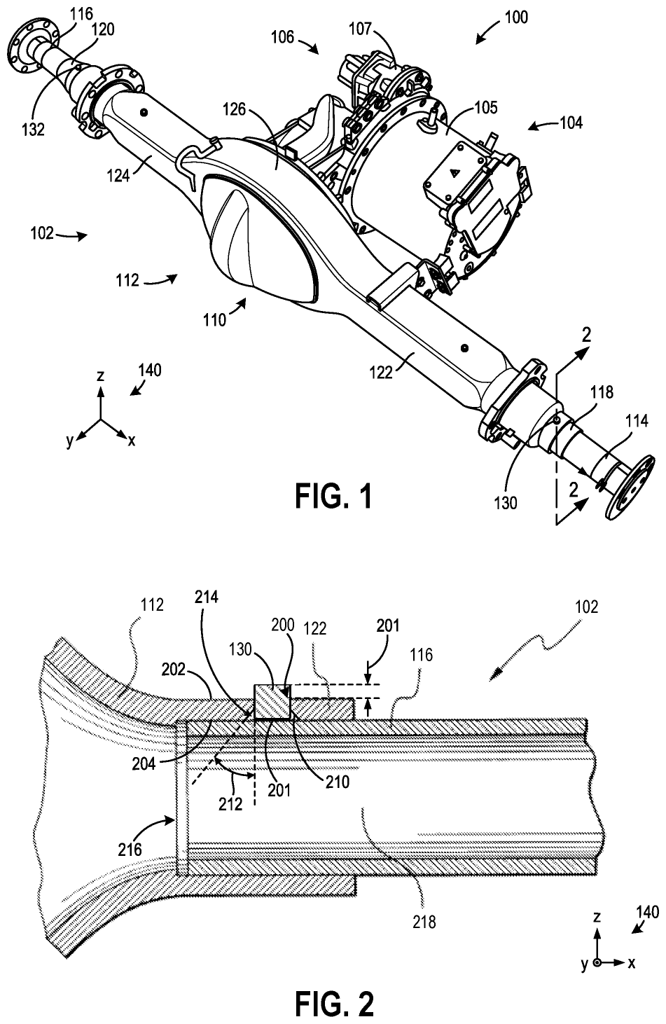

FIGS. 1-2 and 8A-8B are drawn approximately to scale. However, other relative component dimensions may be used in other embodiments.

### DETAILED DESCRIPTION

The following description relates to a method and apparatus for joining first and second axle components, including an axle tube and an axle housing. In an example, the approach described herein may be applied to joining an axle tube to a differential carrier trunnion.

FIG. 1 depicts an example electric drive system 100 for providing power to an axle assembly 102 of a vehicle. The vehicle may take a variety of different forms in different examples, such as a light, medium, or heavy duty vehicle. Additionally, the electric drive system 100 may be adapted for use in front and/or rear axles, as well as steerable and non-steerable axles. To generate power, the electric drivetrain 102 may include an electric machine 104. In some examples, the electric machine 104 may be an electric motor-generator and may thus include conventional components such as a rotor, a stator and the like within an electric machine housing 105 for generating mechanical power as well as electric power during a regenerative mode, in some cases. Further, in other examples, the vehicle may include an additional motive power source, such as an internal combustion engine (ICE) (e.g., a spark and/or compression ignition engine), for providing power to another axle. As such, the electric drive system 100 may be utilized in an electric vehicle (EV), such as a hybrid electric vehicle (HEV) or a battery electric vehicle (BEV).

In some examples, the electric machine housing 105 may be coupled via fasteners, such as bolts, for instance, to a housing 107 of a gearbox 106. Further, the electric machine 104 may provide mechanical power to a differential 110, housed in an axle housing 112, via the gearbox 106 to provide rotational power to axle shafts 114, 116 of the axle assembly 102. As such, the differential 110 may distribute torque, received from the electric machine 104 via the gearbox 106, to drive wheels attached to the axle shafts 114, 116, during certain operating conditions. In some examples, the differential 110 may be a locking differential, an electronically controlled limited slip differential, or a torque vectoring differential.

The gearbox 106 may be a single-speed gearbox, where the gearbox operates in one gear ratio. However, other gearbox arrangements have been envisioned, such as a multi-speed gearbox that is designed to operate in multiple distinct gear ratios. Further, in one example, the electric machine 104, the gearbox 106, and the differential 110 may be incorporated into the axle assembly 102, forming an electric axle (e-axle) in the vehicle. The e-axle, among other functions, provides motive power to drive wheels of the vehicle during operation. Specifically, in the e-axle embodiment, the electric machine and gearbox assembly may be coupled to and/or otherwise supported by an axle housing. In one particular example, the e-axle may be an electric beam axle where a solid piece of material (e.g., a beam, a shaft, and/or a housing) extends between the drive wheels). The e-axle may provide a compact arrangement for delivering power directly to the axle. In other examples, however, the electric machine 104 and the gearbox 106 may be included in an electric transmission in which the gearbox and/or electric motor are spaced away from the axle. For instance, in the electric transmission example, mechanical components such as a driveshaft, joints (e.g., universal joints), and the like may provide a rotational connection between the electric transmission and the drive axle.

FIGS. 1-2 illustrate an example where an axle tube is joined with axle housing, however, the approach described herein may be applied to joining various axle components, and specifically may apply to joining an axle tube to a differential carrier trunnion. In one example, the axle shafts 114, 116 may be disposed in axle tubes 118, 120, respectively, which may be coupled to the axle housing 112. More specifically, the axle tubes 118, 120 may be joined, respectively, to neck portions 122, 124 of the axle housing 112. The neck portions 122, 124 may extend outward in opposing axial directions (e.g., along the x-axis) from a central portion 126 of the axle housing 112 where the differential 110 resides. The axle tubes 118, 120 may be received within an opening defined in each of the respective neck portions 122, 124, and joined thereto, such that the axle shafts 114, 116 may extend through the respective axle tubes and neck portions of the axle housing to receive mechanical power via the differential as desired. As such, the axle shafts 114, 116 may be at least partially enclosed within the axle housing 112.

In some examples, the axle tubes 118, 120 may be joined to the neck portions 122, 124 of the axle housing 112 via a welding process (e.g., a resistance welding process). For instance, each of the neck portions 122, 124 may be provided with a deformable rivet 130, 132, respectively, in one example. In such an example, the deformable rivets may be subjected to heat and pressure in the welding process to join each axle tube to a respective neck portion. The deformable rivets may be cylindrical plugs, balls, or the like made of a metal or other material suitable for welding to the respective axle tube. For simplicity, the axle tube 124 (and deformable rivet 132) will not be discussed further, but it will be understood that the both of the axle tubes, neck portions, and deformable rivets may be similarly configured and/or constructed. Details of the welded connection between the axle tube 118 and the axle housing 112, and formation thereof, will be elaborated on with reference to FIGS. 2-7.

An axis system 140 is provided in FIG. 1, as well as FIGS. 2-4, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

Turning now to FIG. 2, a cross-sectional view of the axle assembly 102 is shown, as defined by a lateral cut taken along dashed line 2-2 shown in FIG. 1. As illustrated in FIG. 2, the neck portion 122 of the axle housing 112 may have an aperture 200 formed therein (e.g., extending between an outer surface/diameter 202 and an inner surface/diameter 204 of the neck) sized to receive the deformable rivet 130. The aperture 200 may therefore be cylindrical and may be formed by drilling, in one example. Further, a chamfer 210 may be formed at one end of the aperture. More specifically, the chamfer 210 may be formed at an inner end of the aperture 200 closer to the axle tube 116. As illustrated, for example, the chamfer may be formed between an interior surface 201 of the aperture 200 and the inner surface 204 of the neck portion 122 of the axle housing 112. The chamfer 210 may be formed, for instance, by cutting away material between the aperture and the inner surface 204. Further, the chamfer 210 may have a chamfer angle 212, as measured between the interior surface 201 of the aperture 200 and the chamfer.

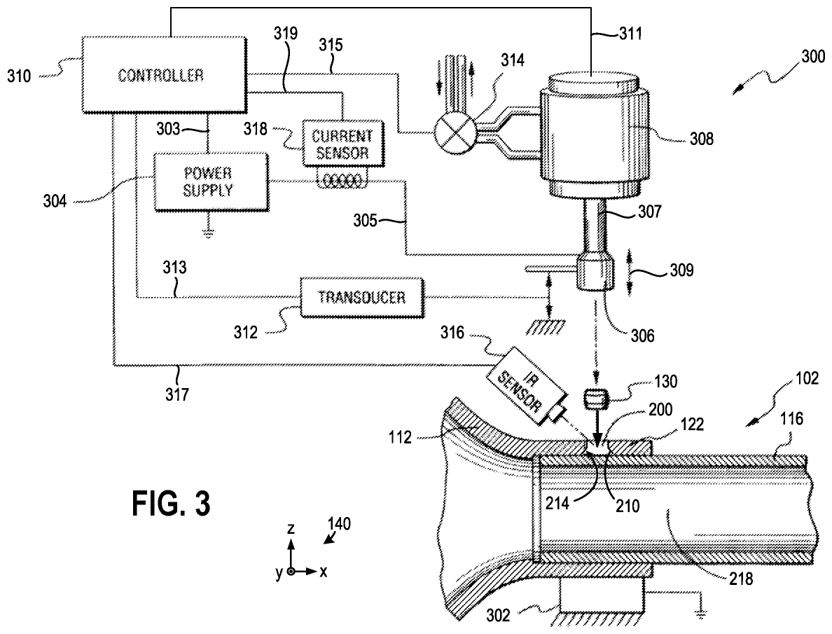

Further, prior to deformation of the deformable rivet 130, the chamfer 210 may form a void 214 defined between the neck portion 122, the axle tube 216, and the deformable rivet 130. Even further, during deformation of the rivet 130, a pressure (e.g., a downward pressure) applied by a joining apparatus may be controlled (e.g., adjusted), based at least in part on the size of the chamfer angle 212, to adequately force material of the deformable rivet into the void 214, where the size of the void is dependent on the chamfer angle. In other words, the pressure and heat applied during the welding process may be controlled so that the deformable rivet 130 fills the void 214 created by the chamfer. In this way, the rivet 130 deforms to create weld having a contact surface area with the axle tube 116 greater than the area of the aperture 200, as will be elaborated on herein with reference to FIGS. 3-7, thereby providing additional torsional strength and resistance at the welded joint.

To elaborate, an end portion 216 of the axle tube 116 may be press-fit or otherwise inserted into an opening 218 in the axle housing 112. The deformable rivet 130 extends through the aperture 200 in the neck portion 122 to meet the axle tube 126. Further, when the deformable rivet 130 is initially inserted into the aperture 200, the rivet may sit proud of the neck portion 122 of the axle housing 112, so as to have an initial height 201 as measured above the neck portion 122. In some examples, the initial height 201 may be at least 5 millimeters (mm). This initial offset between the deformable rivet and the axle housing may allow for better positional control during installation.

The deformable rivet 130 is then welded to the axle tube 116 through the axle housing 112 (e.g., at the aperture 200) causing the axle tube 160 to be joined to the axle housing 112. Although only one deformable rivet is shown extending through the aperture 200, more apertures may be provided to fit respective deformable rivets, in other examples. Further, as noted above while the deformable rivet 130 is described herein for joining an axle tube with an axle housing, it will be understood that the rivet may be used to join two different components (e.g., axle components), where one of the components includes an aperture sized to receive the rivet and having a chamfer at one end thereof proximate the other of the components, in other examples.

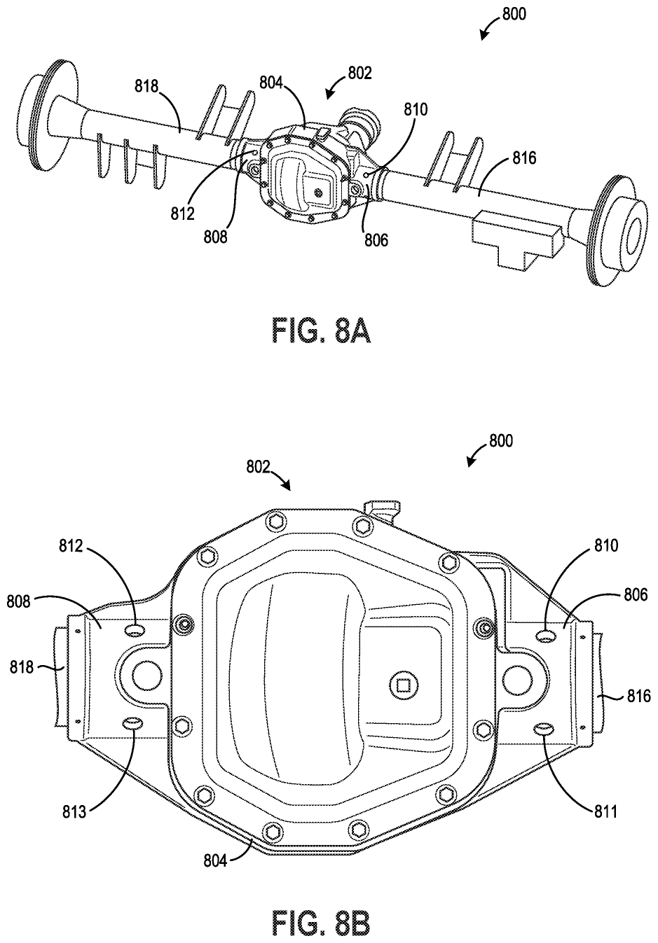

For instance, the deformable rivet may be inserted into an aperture in a trunnion of a differential carrier to join the carrier to an axle tube that is inserted into an opening of the trunnion, in one example, where the aperture again includes a chamfer at an end proximate the axle tube. In such an example, where element 112 denotes a portion of a differential carrier trunnion, it can be joined to axle tube 116. One specific example is illustrated in FIGS. 8A and 8B, showing an e-axle assembly 800, which may be implemented in an electric drivetrain in a light vehicle application. The e-axle assembly 800 may include a differential 802 having a differential carrier 804. Further, the differential carrier 804 may include trunnions 806, 808 integrated therewith and extending in opposing axial directions therefrom. The carrier trunnions 806, 808 further include apertures 810, 812, respectively, formed therein, which apertures may include a chamfer formed at an inner end, similar to the aperture 200 formed in neck portion 122 of the axle housing 112, shown in FIGS. 2-4.

The e-axle assembly 800 may further include axle tubes 816, 818 may be inserted (e.g., in a press-fit manner) into respective carrier trunnions The e-axle 800 may further include axle tubes 816, 818 inserted (e.g., in a press-fit manner) into the trunnions 806, 808, respectively, and coupled thereto by a deformable rivet inserted and welded into the apertures 810, 812. Thus, it will be understood that the apertures formed in the differential carrier 804 are configured to receive deformable rivets such as the deformable rivet 130 discussed with regard to FIGS. 1-4, and a similar joining process and apparatus may be employed to couple the axle tubes 816, 818 to the differential carrier 804 using these deformable rivets. Further, as particularly illustrated in the view of the differential carrier 804 shown in FIG. 8B, the carrier trunnions 806, 808 may include apertures 811, 813 in addition to the apertures 810, 812, which may provide additional points for joining the axle tubes to the carrier (e.g., by welding of deformable rivets inserted into the apertures) to strengthen the connections therebetween.

Returning to the cross-sectional view of the axle assembly 102 of FIG. 2, the deformable rivet 130 is shown to act like a fastener in the aperture 200 of the neck 122 to secure the axle tube 116 to the axle housing 112. As will be described in detail below, the amount of deformation of the deformable rivet 130 is equal to the change in its position between an initial position and a final position. The deformable rivet 130 is in the initial position when it meets the axle tube 116, and in the final position when it is welded to the axle tube 116. The change in position is caused by heat and pressure acting in conjunction on the deformable rivet 130. Further, the loading strength of the deformable rivet 130 depends upon the amount of rivet deformation. As will be expanded upon herein, the pressure applied to the deformable rivet may be controlled (e.g., adjusted) as a function of the size of the chamfer 210 in the aperture 200, such that the rivet 130 deforms to fill the void formed between the chamfer and the axle tube 116. In this way, the resulting weld may have a contact surface area larger than the area of the aperture, providing increased strength and resistance characteristics.

Referring now to FIG. 3, a schematic block diagram illustrating a joining apparatus 300 for joining the axle tube 116 to the axle housing 112 is shown. In one example, the joining apparatus 300 includes an assembly fixture 302 for supporting the axle tube 116 and the axle housing 112 after the portion of the axle tube 116 is inserted within the opening 218. The assembly fixture 302 is mechanically secured to hold the axle assembly 102. Further, the assembly fixture 302, axle tube 116, and axle housing 112 form a conductive path for electricity to travel.

The joining apparatus 300 further includes a resistance heating power supply 304. In one example, the power supply 304 may be a readily obtainable component from various resistance welding component manufacturers such as Weltronic, Medar, or Square D. The power supply 304 has a pair of power output terminals. One of the pair of power output terminals is connected to the assembly fixture 302 in electrical communication with the axle tube 116. The other one of the pair of power output terminals is connected to a hot forging electrode 306.

Further, an actuator 308 may include an output member 307 affixed to the hot forging electrode 306. In one example, the actuator 308 may be in the form of a fluid powered cylinder, though other linear actuators, such as mechanical, electromechanical, piezoelectric actuators and the like, have been contemplated, in other examples. The actuator 308 shifts the hot forging electrode 306 into and out of engagement with the deformable rivet 130, as indicated by arrow 309, to force it against the axle tube 116. When the actuator 308 shifts the hot forging electrode 306 into engagement with the deformable rivet 130, a closed electrical circuit forms between the power supply 304, hot forging electrode 306, deformable rivet 130, axle housing 112, axle tube 116, and assembly fixture 302. As such, the power output from the power supply 304 may then be applied to heat the faying surface, i.e., the interface between the deformable rivet 130 and the axle tube 116, due to resistance in the electric current. The heat causes the deformable rivet 130 to deform and flow into the void 214 formed by the chamfer 210, as will be explained in greater detail below.

The hot forging electrode 306 is movable relative to the deformable rivet 130 to track the deformation of the deformable rivet 130. For example, when the hot forging electrode 306 engages the deformable rivet 130, the deformation of the deformable rivet 130 may be equivalent to the change in the position of the hot forging electrode 306. Hence, the deformation of deformable rivet 130 can be determined by knowing the position of hot forging electrode 306.

The joining apparatus 300 may further include a pressure regulator 314 cooperating with a controller 110, as indicated by line 315, for varying the force exerted by the hot forging electrode 306 on the deformable rivet 130. In some examples, the pressure regulator 314 can be set repeatedly to have the actuator 308 apply differing amounts of pressure. Further, the controller 310 may cooperate with the pressure regulator 314 to vary the force on the deformable rivet 130 as a function of time and of rivet deformation and, in some examples, based on the size (e.g., angle 214) of the chamfer 210. An exemplary strategy for controlling (e.g., varying) pressure applied to the deformable rivet 130 via the hot forging electrode 306 will be discussed with reference to FIG. 5.

The controller 310 may also cooperate with the power supply 304, as indicated by line 303, to regulate the power output of said power supply 304, as shown by line 305. The controller 310 also cooperates with the actuator 308, as indicated by line 311, to further regulate and/or track its movement. The controller 310 may be a readily available component obtainable from various controller manufacturers such as Allen Bradley, Square D, Modicon, or Fanuc.

Further, the controller 310 may include a processor and a memory with instructions stored therein that, when executed by the processor, cause the controller to perform various methods and control techniques described herein. The processor may include a microprocessor unit and/or other types of circuits. The memory may include known data storage mediums, such as random access memory, read only memory, keep alive memory, combinations thereof, and the like. In some examples, the controller 310 may be a programmable logic controller (PLC) having associated A/D converters and a programmed instruction card or a personal computer (PC).

The controller may receive various signals from sensors positioned in the joining apparatus 310 and/or on the axle assembly 102. Conversely, the controller 310 may send control signals to various actuators at different locations based on the sensor signals. For instance, the controller 310 may send command signals to the pressure regulator 314 and, in response, the pressure regulator may adjust a fluid pressure delivered to the actuator 308 to vary the pressure exerted on the deformable rivet 308 via the hot forging electrode 306 (e.g., by the output member 307 of the actuator 308). Other controllable components in the joining apparatus 300 may be operated in a similar manner with regard to sensor signals and actuator adjustment.

The joining apparatus 300 may further include a transducer 312 operative with the hot forging electrode 306. The transducer may be a sensor such as a linear variable deformation transducer (LVDT), in one example, and may provide an output indicative of the position of the hot forging electrode. However, other types of position sensors have been contemplated, in other examples, for determining the position of the hot forging electrode. Further, the controller 310 may cooperate with the transducer 312, as indicated by line 313, to determine the position of the hot forging electrode 306.

After the actuator 308 shifts the hot forging electrode 306 into engagement with the deformable rivet 130, and after the power supply 304 applies power, the controller 310 monitors the position of the hot forging electrode 306 to determine the deformation of the deformable rivet 130. The deformation of the deformable rivet 130 equals the change in position of the hot forging electrode 306 when the hot forging electrode 306 is engaged to the deformable rivet 130. The controller 310 may also regulate the power output of the power supply 304 as a function of rivet deformation to ensure that the deformable rivet 130 properly deforms. Even further, the controller 310 may regulate the power output of power supply 304 by varying the power level and the power duration.

In some examples, the joining apparatus 300 may include an Infra-Red (IR) temperature sensor 316. The temperature sensor 316 may be pointed at the deformable rivet 130 to generate a temperature signal indicative of the temperature of the deformable rivet 130. In some cases, the temperature of the deformable rivet 130 may change to more than 2000° F. from room temperature during the welding process. The controller 310 may cooperate with the IR temperature sensor 316, as indicated by line 317, to determine a temperature of the deformable rivet 310.

Then, the controller 310 may use the temperature signal to determine rivet deformation by comparing the temperature of the deformable rivet 130 with a known deformation pattern. The known deformation pattern is the deformation pattern of a typical deformable rivet subjected to a pressure as a function of its temperature. In some examples, the controller 310 may match the temperature of the deformable rivet 130 to a temperature value in the known pattern to predict the deformation of the deformable rivet 130. Further, the known deformation pattern may, in some cases, account for the size of the void 214 formed by the chamfer 210, when it is desired that the deformable rivet 130 deform so as to fill the void. Since the dimensions and deformation sequences are consistent among deformable rivets, the prediction of the deformation of the deformable rivet 130 made by the controller 310 may be highly accurate. Thus, the controller 310 uses the temperature signal to regulate the power output from power supply 304 as a function of rivet deformation to ensure the deformable rivet 130 properly deforms.

In another example, the joining apparatus 300 may include an electric current sensor 318. The current sensor 318 may be an inductor and may be operative with one of the power output terminals. Further, the current sensor 318 may generate a power consumption signal proportional to the power output from the power supply 304 during the welding process. The controller 310 may cooperate with the current sensor 318, as indicated by line 319, so as to receive the power consumption signal.

The controller 310 may use the power consumption signal to determine rivet deformation by comparing the power applied to the deformable rivet 130 with another known deformation pattern. This known deformation pattern is the deformation pattern of a typical deformable rivet subjected to a pressure as a function of the power applied. The controller 310 may match the power applied to the deformable rivet 130 to a power value in the known pattern in order to predict the deformation of deformable rivet 130. The controller 310 may then use the power consumption signal to regulate the power output of the power supply 304 as a function of rivet deformation to ensure that the deformable rivet 130 properly deforms.

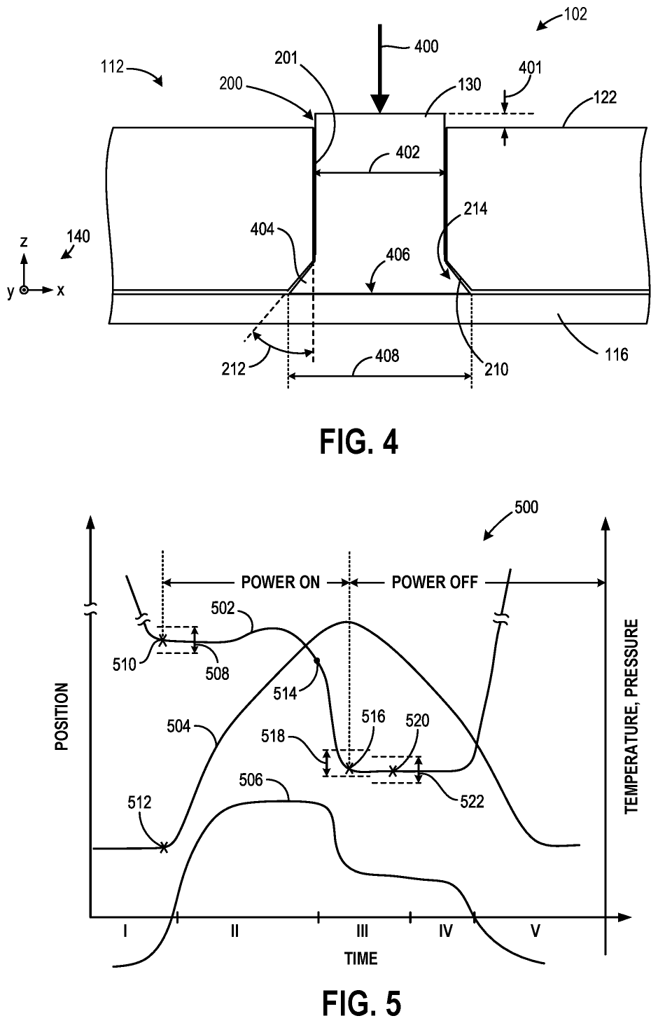

Turning now to FIG. 4, a detailed cross-sectional view of the axle assembly 102 is shown, with cross-hatching omitted for simplicity. More specifically, FIG. 4 shows the deformable rivet 130 positioned in the aperture 200 during heating and deformation of the deformable rivet (e.g., during resistance welding by the joining apparatus 300 depicted in FIG. 3). The deformable rivet 130 has been inserted in the aperture 200 and a downward pressure is applied to the deformable rivet 130, as indicated by arrow 400. As illustrated, the rivet 130 may have a diameter substantially equal to a diameter 402 of the aperture 200, and may therefore be in close proximity with the interior surface 201 of the aperture 200 prior to and during deformation. Further, as downward pressure is applied to the deformable rivet 130, the initial height 200 shown in FIG. 2 (of the deformable rivet relative to the neck portion 122 of the axle housing 112) decreases to a welding height 401 illustrated in FIG. 4. The welding height 401 continues to decrease as pressure and heat are applied to the deformable rivet 130, approaching a final non-zero height. In other words, the final position of the deformable rivet 130 within the aperture 200 may be non-zero so that the deformable rivet is not flush with the neck portion of the axle housing upon completion of the welding process. In one example, when the initial height 200 is at least 5 mm, as previously noted with reference to FIG. 2, the welding height 401 shown in FIG. 4 may approach a final height that is a non-zero value less than 2 mm, or less than 1 mm, such as 0.5 mm, for instance.

During operation of the joining apparatus, lower end of the deformable rivet 130 is in contact with the axle tube 116, and the downward pressure causes the deformable rivet to deform as heat is applied at the aperture 200 (e.g., via the resistance heating power supply 304 shown in FIG. 3). As the rivet 130 deforms, a portion 404 of the deformable rivet flows into the void 214 formed by the chamfer 210, forming a welded connection at a contact surface 406 between the deformed rivet 130 and the axle tube 116 to join the axle tube 116 to the axle housing 112. The contact surface 406 of the weld may thus have a diameter 408 that is larger than the diameter 402 of the aperture 200. In this way, the enlarged contact area provides additional torsional strength and resistance at the welded connection, without sacrificing strength of the axle housing by increasing the diameter 402 of the aperture 200. In other words, increased weld strength between the axle housing and the axle tube may be realized by deforming a rivet to fill an aperture with a chamfer, as described herein, when compared to an aperture having a straight bore (e.g., without a chamfer).

Referring now to FIG. 5, the operation of the joining apparatus 300 will be discussed in greater detail, with joint reference to FIGS. 2-4. FIG. 5 is a graph 500 having an electrode position curve 502, a rivet temperature curve 504, and a pressure curve 506. The electrode position curve 502 illustrates the position of the hot forging electrode 306 as a function of rivet deformation over time. As indicated above, the position of the hot forging electrode 306 tracks the rivet deformation when hot forging electrode 306 is engaged with the deformable rivet 130. The rivet temperature curve 504 illustrates the temperature of the deformable rivet 130 over time. The pressure curve 506 illustrates the pressure on the deformable rivet 130 over time, as applied by the actuator 308.

The time axis is divided into five intervals. The first interval “I” is the fit-up interval. During this interval, the axle tube 116 is inserted into the opening 218 of the axle housing 112 (e.g., of the neck portion 122) mounted on the assembly fixture 302. The deformable rivet 130 is placed in the aperture 200 while the actuator 308 holds the hot forging electrode 306 out of engagement with the deformable rivet 130.

The controller 310 then commands the actuator 308 to shift the hot forging electrode 306 into engagement with the deformable rivet 130. The actuator 308 responds by moving the hot forging electrode 306 until it rests on the deformable rivet 130. Thus, the deformable rivet 130 is in the initial fit-up position. The controller 310 monitors the initial position of the hot forging electrode 306. If the initial position of the hot forging electrode 36 falls within a predetermined initial fit-up range 508, such as initial position point 510 on the position curve 502, then the controller 310 commands the power supply 304 to apply power as shown by “power on” point 512, near the end of interval I. The predetermined initial fit-up range 508 is indicative of a proper fit-up of the deformable rivet 130.

The second interval “II” is the resistance welding interval. During this interval, the hot forging electrode 306 applies a constant high pressure on the deformable rivet 130. Preferably, for the manufacturing of axle assemblies according to the examples described herein, the constant high pressure may be around 3000-5000 pounds per square inch (psi), though other suitable pressure ranges have been considered in other examples, depending upon the application. The hot forging electrode 306 also applies the electrical current from the power supply 304 to the deformable rivet 130. Due to the resistance of the deformable rivet 130, the power is dissipated into heat energy. Thus, the current heats the deformable rivet 130 as shown by the rising slope of rivet temperature curve 504 in interval II.

The power applied by the power supply 304 may be AC or DC electrical power. It may also take a variety of input patterns such as pulse, ramp, sinusoidal, sawtooth, etc. depending upon the application, the type of power supply, and on the thicknesses and type of materials used. In one example, mid-frequency direct current (MFDC) may be applied by the power supply 304, where AC power is inverted and converted to an inverted DC output. Using MDFC in the welding process may allow for faster and more reliable heating of the deformable rivet, to ensure adequate weld quality as desired, while also reducing inductive power losses for improved energy efficiency. Further, the use of MFDC may lead to reduced pressure demands (e.g., from the actuator 308), which may help to reduce the chance of excessive heat deformation at the axle tube and/or housing. In other examples, for the manufacturing of axle assemblies as described herein, the power output may be pulsed with a frequency of around 60 Hertz, a duty cycle of around 50%, and 18,000 to 25,000 amps RMS of secondary current. Further, during interval II, the power supply 304 may apply power for around 10 to 20 cycles, such as 10 to 15 cycles, for instance, depending on the current level demanded in a particular application.

At the beginning of interval II deformable rivet 130 maintains its initial position. The deformable rivet 130 begins to expand and may then start to contract once it reaches a sufficient temperature. The slight expansion and contraction are shown by the electrode position curve 502 in interval II. As the deformable rivet 130 initially expands, the high pressure applied during interval II causes the material of the deformable rivet to begin to flow into the void 214 formed by the chamfer 210 as the temperature of the rivet increases. After the deformable rivet 130 initially expands, it may continue to soften and begin to collapse under the application of pressure and heat. Because of the pressure and the heat generated from the power output, the deformable rivet 130 may then coalesce with the axle tube 116 and become welded to it. This process is the basis of resistance welding.

Once the deformable rivet 130 contracts to a sufficient level such as forge point 514 on the position curve 502, the controller 310 commands the actuator 308 to step (e.g., instantaneously) the constant high pressure applied on hot forging electrode 306 to a constant lower pressure. Preferably, for the manufacturing of axle assemblies described herein, the constant low pressure may be around 2000 psi, depending on the size of the deformable rivet 130, though other suitable pressure ranges have been considered in other examples, depending upon the application. In turn, the hot forging electrode 306 applies the constant low pressure on the deformable rivet 130. The pressure changing instantaneously from high to low on a sufficiently heated deformable rivet 130 is the basis of the hot forging process described herein. However, it is not required for the high and low pressures to be constant. The instantaneous change of pressure is shown by the pressure curve 506 at the beginning of the forging interval “III”. Thus, an advantage of the present invention is that the controller 310 monitors the deformation of the deformable rivet 130 during the resistance welding interval to determine precisely when to command the actuator 308 to step down the pressure.

Depending on the application, an increase in power output from the power supply 304 may be required during the forging interval, particularly when it is desired that the deformable rivet 130 deform so as to substantially fill the void 214 formed by the chamfer 210. As such, the controller 310 may command the power supply 304 to adjust the power output accordingly. Also, a delay of about one to five cycles may be required to allow the deformable rivet 130 a chance to cool to properly coalesce with the axle tube 116 before forging. If so, the controller 310 will command the power supply 304 accordingly.

Once the actuator 308 applies the constant high pressure (at interval II), the deformable rivet 130 contracts rapidly. The rapid contraction is shown by the drastic change of the position curve 502 at the beginning of the interval III. The controller 310 receives the output of the transducer 312, which monitors the contraction of the deformable rivet 130. The controller 310 then commands the power supply 304 to terminate the power once the deformable rivet 130 contracts to a sufficient level, such as calculated position point 516 on the position curve 502. The calculated position point 516 is within a predetermined position range 518. The rivet temperature starts to decrease after the power output is terminated, as shown by the rivet temperature curve 504 in interval III.

After the deformable rivet 130 has rapidly contracted to the calculated position point 516 within the predetermined position range 518, it gradually contracts under the low constant pressure of the hot forging electrode 306 until it reaches the final position point 520. The final position point 520 is within the final position “envelope” 522 on the electrode position curve 502. Further, the position of the hot forging electrode 306 falling within the final position envelope 522 is indicative of proper rivet deformation. The controller 310 will identify the axle assembly 102 as defective if the position of the hot forging electrode 306 does not fall within the final position envelope 522. In this way, the joining apparatus 300 may reliably determine proper welding of the axle assembly components.

When the position of the hot forging electrode 306 reaches the final position point 520, or any other point within the final position envelope 522, the cooling interval “IV” commences. During the cooling interval, the temperature of the deformable rivet 130 continues to decrease, as shown by the rivet temperature curve 504 in interval IV. The controller 310 may command the actuator 308 to keep continuing to apply the constant low pressure on the hot forging electrode 306. In turn, this allows the deformable rivet 130 a chance to cool. Upon cooling, the deformable rivet 130 becomes forged to the axle tube 116. Thus, the axle tube 116 may be permanently joined to the axle housing 112.

The controller 310 then commands the actuator 308 to retract the hot forging electrode 306. During this retraction interval “V”, the hot forging electrode 306 is shifted out of engagement with the deformable rivet 130. The controller 310 may continue to monitor the position of the hot forging electrode 306 to ensure that it actually has retracted to avoid any “stuck gun” conditions (e.g., where the hot forging electrode 306 becomes fused to the deformable rivet 130). In other words, the controller 310 makes sure that hot forging electrode 306 has retracted before transfer of the axle assembly 102, for guarding the operator and the equipment against harm or damage. This allows the axle assembly 102 to be removed from the assembly fixture 302, and the operation of the joining apparatus 300 can be repeated on a new axle assembly as desired.

The operation of a preferred embodiment of the joining apparatus 300 having the transducer 312 to monitor the position of the hot forging electrode 306 by measuring the movement of the hot forging electrode 306 has just been described. In an alternate example, the temperature sensor 316 may be used instead of the transducer 312 to monitor the position of the hot forging electrode 306. In yet another alternate example, the current sensor 318 may be used instead of the transducer 312 to monitor the position of the hot forging electrode 306. The difference among all of the examples is how the position of hot forging electrode 306 is obtained. Thus, the graph 500 would still be applicable no matter which embodiments are used.

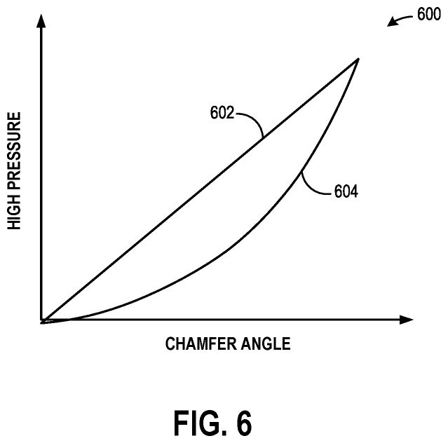

With continuing reference to FIG. 5, FIG. 6 shows a graph 600 illustrating examples of how the pressure applied to the deformable rivet 130 is adjusted, specifically showing a relationship between the maximum pressure applied during the high pressure resistance welding interval II and the chamfer angle (e.g., angle 212 of chamfer 210). The chamfer angle is indicated on the abscissa and increases in the direction of the arrow, and the pressure is indicated on the ordinate and increases in the direction of the arrow.

In one example, as indicated by plot 602, the high (e.g., maximum) pressure level applied during resistance welding interval II may increase proportionally with an increase in the chamfer angle. In another example, as indicated by plot 604, the high pressure level applied during resistance welding interval II may increase exponentially with an increase in the chamfer angle. In these and other exemplary pressure and angle relationships, it will be understood that a larger chamfer angle may require a larger pressure to allow the deformable rivet to sufficiently (e.g., substantially) fill the chamfer during the resistance welding interval.

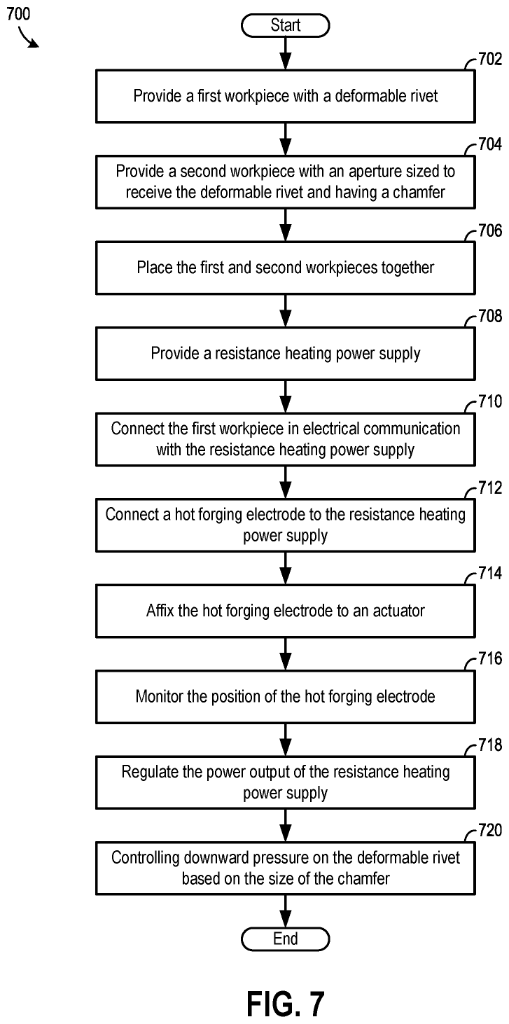

Referring now to FIG. 7, a flow chart illustrating a hot forging method 700, according to one example, is shown. The hot forging method 700 includes the steps of providing a first workpiece (e.g., axle tube 116, shown in FIGS. 1-4) with a deformable rivet (e.g., deformable rivet 130, shown in FIGS. 2-4), as shown in block 702, and providing a second workpiece with an aperture having a chamfer (e.g, neck portion 122 of axle housing 112, with the aperture 200 having chamfer 210, shown in FIGS. 2-4) sized to receive the deformable rivet, as shown in block 704. Next, at block 706, the first and second workpieces are placed together with the deformable rivet of the first workpiece extending through the aperture in the second workpiece.

A resistance heating power supply having a pair of power output terminals is then provided, as shown in block 708. One of the power output terminals is connected in electrical communication to the first workpiece, as shown in block 710. Next, a hot forging electrode movable relative to the deformable rivet is connected to the other one of the power output terminals as shown in block 712.

Next, at block 714, an actuator is affixed to the hot forging electrode. The actuator shifts the hot forging electrode into and out of engagement with the deformable rivet. The position of the hot forging electrode is then monitored to determine rivet deformation, as shown in block 716. Then, the power output of the resistance heating power supply is regulated as a function of rivet deformation to ensure that the deformable rivet properly deforms, as shown in block 718.

The actuator is controlled to regulate a pressure (e.g., a downward pressure) on the deformable rivet, as shown in block 720. In some examples, the pressure applied and/or the change in the pressure applied, may be dependent on the size of the chamfer in the aperture between the first and second workpieces. In one example, the pressure applied may be proportional to an angle of the chamfer (as denoted by angle 212 shown in FIGS. 2 and 4), as shown by plot 602 in FIG. 6. For instance, a higher pressure may be applied to the deformable rivet (e.g., during interval II shown in FIG. 5) when the chamfer angle is larger. Conversely, when the chamfer angle is smaller, a lower pressure may be desired, wherein the pressure should be sufficient to encourage a flow of heated (e.g., melted) deformable rivet into the chamfer area (e.g., void 214). In this way, the pressure on the deformable rivet can be controlled during the joining process (in which the first and second workpieces are joined via the deformable rivet) to force material of the deformable rivet, during deformation thereof, into the void defined by the chamfer. Thus, the contact area of the rivet weld between the first and second workpieces can be increased without increasing the general size of the aperture. In this way, the contact area of the weld joining the first and second workpieces may be wider than the area of the aperture formed in the first workpiece, thereby increasing resistance strength of the weld joint. Further, by allowing for a reduced area of the majority of the aperture (e.g., without the chamfer area), the potential for premature degradation and/or separation of components may be reduced.

The present invention may also be applied to join a first workpiece having an integral deformable rivet to a second workpiece having a corresponding aperture for receiving the integral deformable rivet. Here, no separate deformable rivet is used. However, in other examples, the deformable rivet may be provided as a separate component inserted into the aperture of the second workpiece so as to contact the first workpiece. Further, while the examples described herein have focused on joining an axle tube to an axle housing, other applications of the joining process described herein have been contemplated. For instance, a similarly welded deformable rivet may be utilized in the joining of an axle tube to a carrier of a differential. However, it will be understood that the joining processes and weld couplings discussed herein may be implemented for joining components in a variety of assemblies, not limited to axle assemblies and/or vehicle systems.

FIGS. 1-4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The invention will be further described in the following paragraphs. In one aspect, a method is provided that comprises: forming an aperture in a first axle component, the first axle component mounted to a second axle component, the aperture having a chamfer on one end of the aperture; inserting an object into the aperture, the object sized to fit into the aperture; and resistance welding at the aperture while pressing on the object with a variable pressure, the pressure adjusted to be at a first, higher level during a first portion of the welding and then at a second, lower level during a second later portion of the welding as the object fills the chamfer. In one example, the one end of the aperture may be closer to the second component than another end of the aperture. In another example, the object may be a slug. In yet another example, the pressure may be adjusted based on an angle of the chamfer. In a further example, the higher the angle, the higher the first pressure level may be. In another example, the first pressure level may be proportionally increased for an increase in the angle. In another example, the method may further comprise powering on a resistance heating power supply during the first portion and powering off the power supply during the second later portion of the welding. In another example, the method may further comprise completing the resistance welding after the second portion. In another example, the first axle component may be a differential carrier. In another example, the second axle component may be an axle tube. In yet another example, one of the first and second axle components may be coupled with an electric drive.

In another aspect, a method is provided that comprises forming a cylindrical aperture in a first axle component, the first axle component mounted to a second axle component, the aperture having a chamfer on an end of the aperture adjacent to the second component, the chamfer having a side wall at a fixed angle relative to a central axis of the aperture; inserting a cylindrical slug into the aperture, the slug sized to fit into the aperture; and resistance welding at the aperture while pressing on the slug with a variable pressure, the pressure adjusted to be at a first, higher level during a first portion of the welding and then at a second, lower level during a second later portion of the welding as the slug fills the chamfer. In one example, the pressure may be adjusted based on an angle of the chamfer. In another example, the higher the angle, the higher the first pressure level may be. In yet another example, the first pressure level may be proportionally increased for an increase in the angle. In another example, the method may further comprise powering on a resistance heating power supply during the first portion and powering off the resistance heating power supply during the second later portion of the welding.

In yet another aspect, an electric axle is provided that comprises an electric drive; an axle having a first component and a second component joined by a slug weld formed via a slug in an aperture, the aperture having a chamfer on an end of the aperture adjacent to the second component, the chamfer having a side wall at a fixed angle relative to a central axis of the aperture, the slug filling the aperture including the chamfer.

In any of the aspects or combinations of aspects, the aperture may be cylindrical.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
forming an aperture in a first axle component, the first axle component mounted to a second axle component, the aperture having a chamfer on one end of the aperture;
inserting an object into the aperture, the object sized to fit into the aperture; and
resistance welding at the aperture while pressing on the object with a variable pressure, the pressure adjusted to be at a first, higher level during a first portion of the welding and then at a second, lower level during a second later portion of the welding as the object fills the chamfer.

2. The method of claim 1, wherein the one end of the aperture is closer to the second component than another end of the aperture.

3. The method of claim 2, wherein the object is a slug.

4. The method of claim 3, wherein the pressure is adjusted based on an angle of the chamfer.

5. The method of claim 4, wherein the higher the angle, the higher the first pressure level.

6. The method of claim 5, wherein the first pressure level is proportionally increased for an increase in the angle.

7. The method of claim 1, further comprising powering on a resistance heating power supply during the first portion and power off the RF source during the second later portion of the welding.

8. The method of claim 7, further comprising completing the resistance welding after the second portion.

9. The method of claim 8 wherein the first axle component is a differential carrier.

10. The method of claim 8 wherein the second axle component is an axle tube.

11. The method of claim 1 wherein one of the first and second axle components is coupled with an electric drive.

12. A method, comprising:
forming a cylindrical aperture in a first axle component, the first axle component mounted to a second axle component, the aperture having a chamfer on an end of the aperture adjacent to the second component, the chamfer having a side wall at a fixed angle relative to a central axis of the aperture;
inserting a cylindrical slug into the aperture, the slug sized to fit into the aperture; and resistance welding at the aperture while pressing on the slug with a variable pressure, the pressure adjusted to be at a first, higher level during a first portion of the welding and then at a second, lower level during a second later portion of the welding as the slug fills the chamfer.

13. The method of claim 12, wherein the pressure is adjusted based on an angle of the chamfer.

14. The method of claim 13, wherein the higher the angle, the higher the first pressure level.

15. The method of claim 14, wherein the first pressure level is proportionally increased for an increase in the angle.

16. The method of claim 15, further comprising powering on a resistance heating power supply during the first portion and power off the RF source during the second later portion of the welding.

17. An electric axle, comprising:
an electric drive;
an axle having a first component and a second component joined by a slug weld formed via a slug in an aperture, the aperture having a chamfer on an end of the aperture adjacent to the second component, the chamfer having a side wall at a fixed angle relative to a central axis of the aperture, the slug filling the aperture including the chamfer.

18. The electric axle of claim 17 wherein the aperture is cylindrical.

19. The electric axle of claim 18 wherein the slug protrudes proud of the aperture.
